(19) United States
(12) Patent Application Publication
(10) Pub. No.: US 2012/0193480 A1
(43) Pub. Date: Aug. 2, 2012

(54) AIRCRAFT LOADING VEHICLE

(75) Inventors: Michael Anthony Carreon, Arlington, TX (US); Douglas Joseph Berkelbaugh, Puyallup, WA (US); Andrew Paul Davis, Irving, TX (US); Howard Lee Janco, Dallas, TX (US); Ralph William Jankowski, Denton, TX (US); Michelle Nicole Muller, Cedar Hill, TX (US); Uwe Wolfgang Plefka, Hurst, TX (US); Nihar Ranganathan, Irving, TX (US); Thomas Roland Ryskasen, Scotch Plains, NJ (US); Sharon Jean Schmitz, Westworth Village, TX (US); Andrew David Trabosh, Lantana, TX (US); Robert Edward Blackburn, JR., Grapevine, TX (US); Christy Anne Johnson, Mableton, GA (US); James G. Gallanis, Chicago, IL (US); Selatin Mujezic, Little Village, NY (US); Gerald Lenard Nigro, Flower Mound, TX (US); Christopher Price, Dallas, TX (US); Don Eugene Hinderliter, II, Richardson, TX (US)

(73) Assignee: Arlington Services, Inc.

(21) Appl. No.: 13/016,870

(22) Filed: Jan. 28, 2011

(51) Int. Cl. B64D 9/00

(52) U.S. Cl. 244/137.1; 414/809

(57) ABSTRACT

According to one aspect of an exemplary embodiment of the present disclosure, an aircraft loading/unloading vehicle includes a chassis and a first driving position located at the front of the aircraft loading vehicle. The vehicle also includes a loading platform that is coupled to the chassis. The loading platform is vertically moveable to reach a doorsill height of an aircraft. A cargo cabin is also coupled to the chassis. The cargo cabin encloses a second driving position that allows a driver to face rearward. The second driving position includes a steering controller, a gear selector, and a brake.

### BACKGROUND

Aircraft, particularly commercial airliners, often fly with food and drink for the passengers to enjoy in flight. The food may be provided to the airlines by a company that specializes in preparing meals specifically for airline passengers and crew. This food may be transported by catering trucks specifically designed to be loaded with catering carts and to deliver these carts to the galley of the aircraft. As such, these catering trucks travel and must be carefully maneuvered on crowded commercial airport tarmacs or ramps.

### SUMMARY

According to one aspect of an exemplary embodiment of the present disclosure, an aircraft loading/unloading vehicle includes a chassis and a first driving position located at the front of the aircraft loading vehicle. The vehicle also includes a loading platform that is coupled to the chassis. The loading platform is vertically moveable to reach a doorsill height of an aircraft. A cargo cabin is also coupled to the chassis. The cargo cabin encloses a second driving position that allows a driver to face rearward. The second driving position includes a steering controller, a gear selector, and a brake.

According to another aspect of an embodiment of the present disclosure, a method of loading and/or unloading an aircraft includes driving a loading vehicle from a first driving position in a forward direction of travel toward an aircraft. The driver in the first driving position faces the forward direction of travel. A loading platform that can support cargo is positioned proximate the aircraft. The cargo is loaded onto the aircraft, and the loading vehicle is driven in a reverse direction of travel away from the aircraft by the driver in a second driving position. The driver in the second driving position is facing the reverse direction of travel.

In one embodiment, the aircraft loading vehicle of the present disclosure may allow a single driver to operate the vehicle, including reversing the vehicle on a crowded airport tarmac. There may be restrictions prohibiting reversing a vehicle when part of that vehicle blocks the rearward view of a driver. According to embodiments of the present disclosure, a driver may reverse the vehicle from an alternate driving position located in a cargo cabin that allows the driver to face rearward and have substantially unobstructed sight lines out of the vehicle.

Another technical advantage may include the ability for a single individual to operate the aircraft loading vehicle and load and/or unload an aircraft with catering carts without assistance from others. The driver may position the vehicle near the aircraft, then load a loading platform with wheeled catering carts. The driver may then stand on the platform and raise it to the height of the doorsill of the aircraft. The cargo cab of the vehicle may not raise with the platform. The loading platform may be elevated to allow a regional jet to be catered by an airline catering service associated with the vehicle. After loading and/or unloading the aircraft, the driver may reverse the vehicle away from and clear of the aircraft without the assistance of a spotter.

Other technical features may be readily apparent to one skilled in the art from the following figures, descriptions, and claims.

### BRIEF DESCRIPTION OF THE DRAWINGS

FIG. 1 is an environmental view of an aircraft loading vehicle approaching an aircraft according to an embodiment of the present disclosure;

FIG. 2 is an environmental view of an aircraft loading vehicle of FIG. 1 reversing away from an aircraft according to an embodiment of the present disclosure;

FIG. 3 is a detailed view of an alternate driving position of the aircraft loading vehicle of FIG. 1 according to an embodiment of the present disclosure;

FIG. 4 is an environmental view of the aircraft loading vehicle of FIG. 1 showing cargo to be loaded onto the aircraft according to an embodiment of the present disclosure;

FIG. 5 is an isometric view of the aircraft loading vehicle of FIG. 1 according to an embodiment of the present disclosure; and

FIG. 6 is a flow diagram for a method of loading an aircraft according to an embodiment of the present disclosure.

### DETAILED DESCRIPTION

In the following description of an aircraft loading vehicle and method of loading and/or unloading cargo onto an aircraft, like numbers refer to like parts.

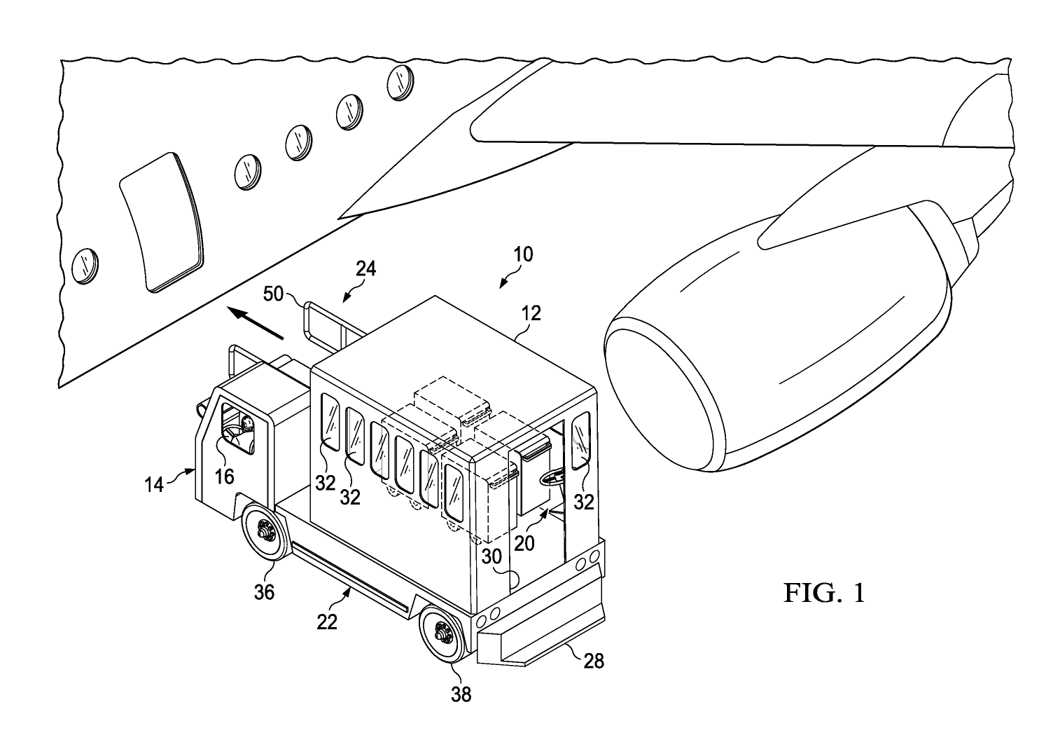

FIG. 1 shows an environmental view of a system for loading and/or unloading cargo between an aircraft loading vehicle 10 and an aircraft. The aircraft loading vehicle 10 includes a cargo cabin 12, a chassis 22, and a cab 14. The cab 14 encloses a cab driving position 16. The cab driving position 16 may be the primary driving position when operating the aircraft loading vehicle 10. A driver may operate the loading vehicle 10 using the steering wheel, service brakes, accelerator, parking brake, gear selector and the like as a conventional vehicle is operated. For example, a driver may sit in the cab driving position 16 and drive the aircraft loading vehicle 10 from a food preparation facility to an aircraft in order to load the cargo received from the facility. The driver may operate the aircraft loading vehicle 10 from the cab driving position 16 and maneuver the aircraft loading vehicle 10 over the road and on the tarmac towards an aircraft. Upon reaching the desired position proximate the aircraft to be loaded and/or unloaded, the driver may apply the parking brake, apply chocks to the wheels, and proceed to load the cargo transported by the aircraft loading vehicle 10 onto the aircraft. The aircraft loading vehicle 10 may be driven at any suitable speed. In certain embodiments, a maximum speed may be between 25 and 30 miles per hour.

In certain embodiments, the aircraft loading vehicle 10 may have an alternate driving position 20, which may be enclosed by the cargo cabin 12. The alternate driving position 20 may allow the driver to operate the aircraft loading vehicle 10 in reverse to move it away from the aircraft on a crowded tarmac or commercial airline ramp. The aircraft loading vehicle 10 may be safely reversed because the driver in the alternate driving position 20 is positioned to see in the direction of travel through one or more cargo cabin windows 32 and a rear doorway 30. The cargo cabin windows 32 may be on rear and side walls of the cargo cabin 12.

Airport restrictions and/or airline regulations may require a spotter outside of the vehicle to direct a driver who reverses a vehicle when the view behind the driver is obstructed by part of the vehicle being reversed. These restrictions may be intended to promote safety on a tarmac where there is significant aircraft and vehicle traffic and pedestrian activity. In accordance with embodiments of the present disclosure, the need for an individual spotter to guide the reverse of the vehicle may be eliminated because the driver can reverse the vehicle from the alternate driving position 20 without his view being obstructed by a portion of the vehicle, such as the cargo cabin 12. Because the driver can see through the cargo cabin windows 32 and the rear doorway 30 of the cargo cabin 12, he may be able to avoid any aircraft, ground support equipment, or personnel while reversing the aircraft loading vehicle 10 to back off the aircraft.

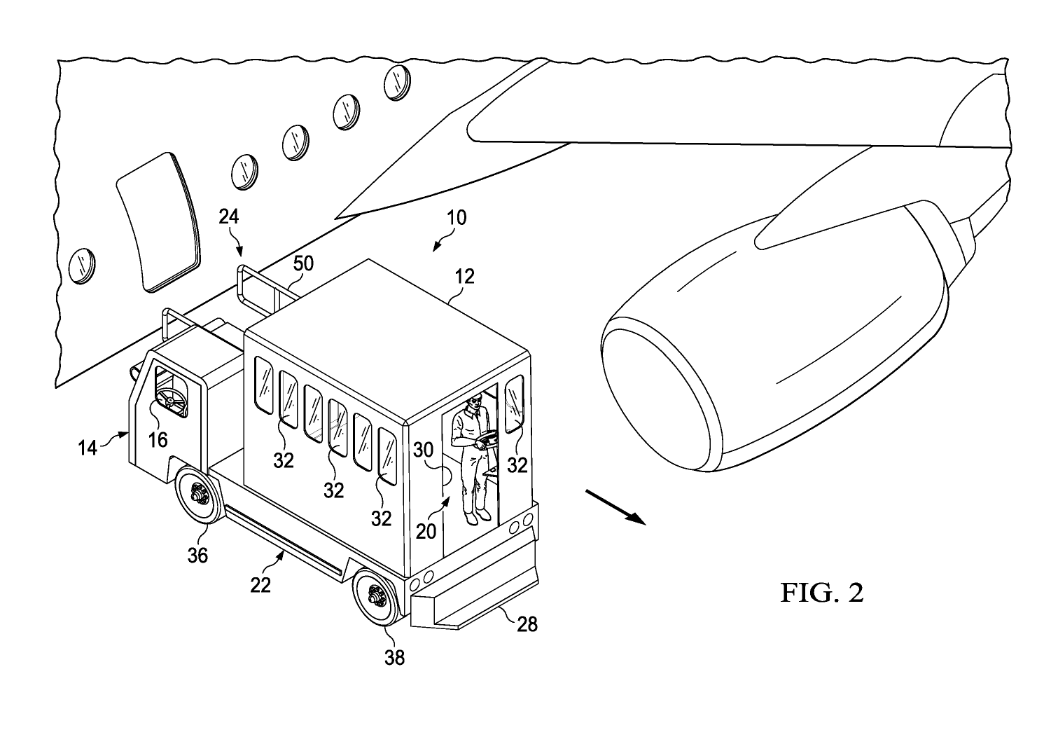

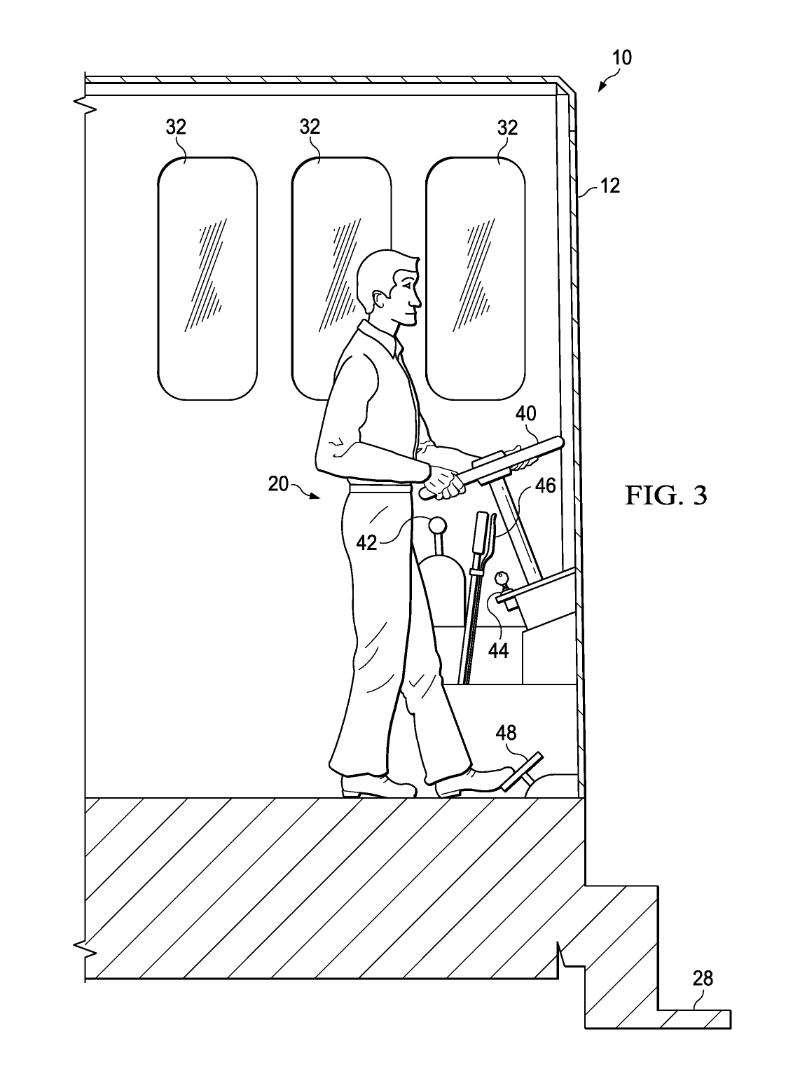

As shown in FIGS. 2 and 3, the alternate driving position 20 may include features to allow the vehicle to be reversed by a standing driver. The alternate driving position 20 may include an alternate ignition switch 44. The alternate ignition switch 44 may allow the driver to kill the engine from the cab driving position 16, and after safely loading the cargo with the engine off, the driver may enter the cargo cabin 12 and start the engine of the aircraft loading vehicle 10 using the alternate ignition switch 44. Similarly, once the driver backs the aircraft loading vehicle 10 away from the aircraft, he may kill the engine and walk safely to the cab driving position 16 to drive the vehicle 10 to its next destination.

The alternate driving position 20 may also include an alternate gear selector 42. The alternate gear selector 42 may allow the aircraft loading vehicle to be placed in reverse from the alternate driving position 20. In addition, the alternate gear selector may allow the vehicle to be placed in neutral or park. In certain embodiments, the vehicle 10 may be more safely operated because the alternate gear selector 42 may not allow a driver in the alternate driving position 20 to put the vehicle into forward drive gear.

According to one embodiment, the alternate driving position 20 may only allow the driver to operate the vehicle at an idle speed. There may be no accelerator functionality available to the driver from the alternate driving position 20. In other embodiments, reversing the alternate aircraft loading vehicle 10 from the alternate driving position 20 may be done in the conventional manner where the driver in the alternate driving position 20 may accelerate the aircraft loading vehicle 20 in reverse.

The alternate driving position 20 may also include an alternate service brake 48. In certain embodiments, the alternate service brake 48 may be a pedal. In other embodiments, the alternate service brake 48 may be a hand brake. An alternate parking brake 46 may also be accessed by the driver in the alternate driving position 20.

The alternate driving position 20 may also include an alternate steering wheel 40. The alternate steering wheel 40 may allow the driver to steer the vehicle 10 from the alternate driving position 20. In certain embodiments, the alternate steering wheel 40 may steer the front wheels 36 of the aircraft loading vehicle 10. In this manner, the front wheels 36 may be steered opposite the direction of travel of the aircraft loading vehicle 10. This type of steering is known in the art and is a common method of steering forklifts and other material handling or excavating vehicles.

The aircraft loading vehicle 10 may be equipped with hydraulic steering such that rotating the alternate steering wheel 40 causes pressurized hydraulic systems mounted on the chassis 22 to assist the movement of the front wheels 36. The chassis 22 may be similar to a mobile belt loader manufactured by Tug Technologies Corp., Model No. 660. According to one embodiment, the steering system may be an orbitrol-operated hydraulic cylinder steering system that allows the front wheels 36 to be steered by the steering wheel in the cab driving position 16 and by the alternate steering wheel 40. Mechanical input applied at the alternate steering wheel 40 may cause appropriate mechanical linkages to turn the front wheels 36. In an alternate embodiment, the alternate steering wheel 40 may steer the rear wheels of the vehicle while the front wheels remain substantially in line with the vehicle. In still other embodiments, all four wheels of the vehicle may be steered by the driver using the alternate steering wheel 40.

The engine that drives the aircraft loading vehicle 10 may be powered by gasoline, diesel fuel, electricity or some combination thereof. In alternate embodiments, the aircraft loading vehicle 10 may be powered by liquid propane. The chassis 22 may also include a solid mount suspension system. The chassis 22 may support a loading platform 24 and the cargo cabin 12 to allow the aircraft loading vehicle 10 to function as a catering truck.

The cargo cabin 12 may be secured to the chassis 22. The aircraft loading vehicle 10 may function as a catering vehicle even through the cargo cabin 12 may not elevate away from the chassis 22. In conventional aircraft catering vehicles, the cargo cabin raises away from the chassis to be approximately level with the doorsill of the aircraft and the cargo can be easily moved from the cargo cabin 12 to the aircraft.

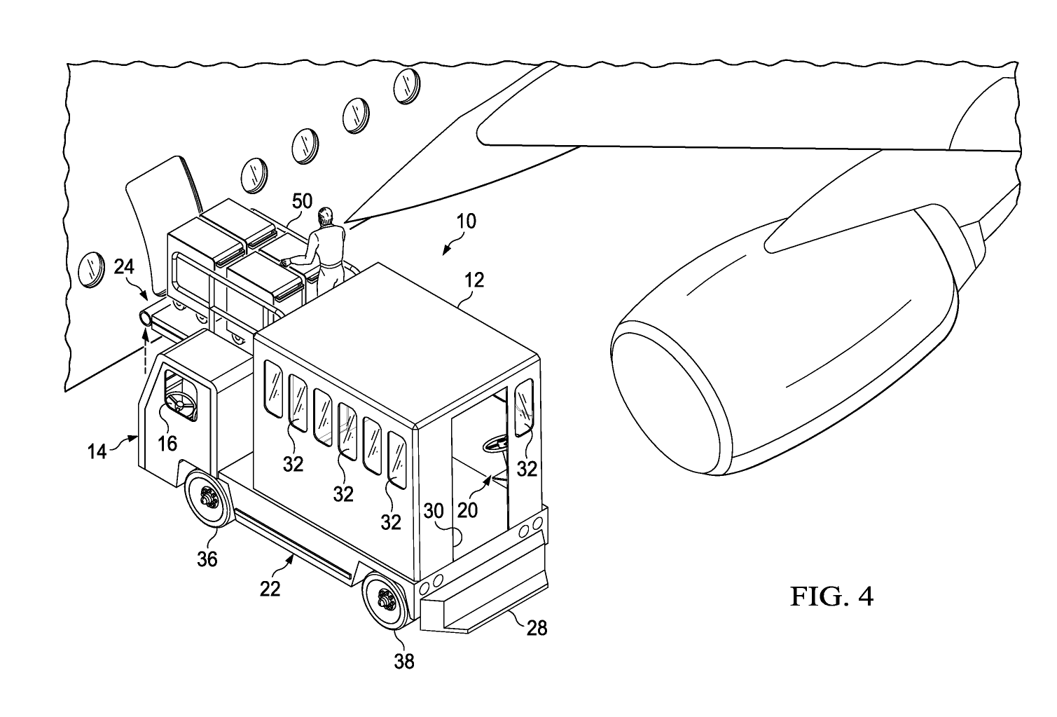

According to embodiments of the present disclosure, a loading platform 24 may be loaded with the cargo transported in the cargo cabin 12 as shown in FIG. 4. The cargo may be wheeled catering carts. Once the catering carts are loaded on the loading platform 24, the loading platform 24 may be elevated to approximately the height of the aircraft doorsill. In certain embodiments, the loading platform 24 may reach doorsill heights between 36 and 78 inches. This height may allow regional jets to receive aircraft catering. In other embodiments, the loading platform 24 may elevate higher than 78 inches to serve larger aircraft, or lower than 36 inches. To serve intercontinental jet airliners, the loading platform 24 of the aircraft loading vehicle 10, according to an embodiment of the present disclosure, may reach an aircraft doorsill height of up to 228 inches. The driver or other individual loading the aircraft may be elevated on the loading platform 24 together with the cargo. Safety for this individual may be provided by the handrails 50.

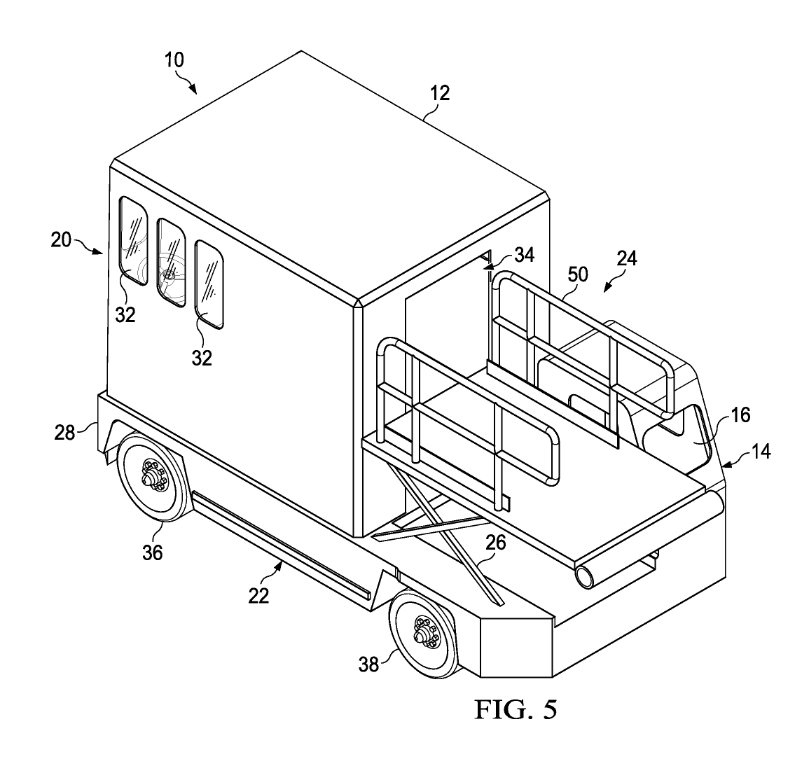

The elevation of the loading platform 24 may be accomplished by a lift system 26 as shown in FIG. 5. The lift system 26 may be a scissor lift system that is known in the art. The loading platform 24 may be located toward the front of the vehicle 10 and beside the cab 16. In this embodiment, the cab 16 may be a half-cab, which may only have space for one person as the driver. The loading platform 24 may raise and lower along the height of a front cabin doorway 34, while the cargo cabin 12 remains fixed. In other embodiments, the cargo cabin 12 may raise and lower as is common in conventional aircraft catering trucks.

A method 60 of loading an aircraft is illustrated by the flow diagram as shown in FIG. 5. An aircraft may be unloaded according to the teachings of the present disclosure as well. The method 60 starts at step 62 where an aircraft loading vehicle 10 is driven toward an aircraft from a cab driving position 16. The cab driving position 16 may be a forward or front driving position. Once the aircraft loading vehicle 10 is positioned in a suitable position for loading the aircraft, it may be parked, and the cargo may be moved from the cargo cabin 12 to the loading platform 24 at step 64. The loading platform 24 may be in a lowered position and may hold approximately four catering carts to supply food and drinks to a regional jet. The wheeled catering carts may be rolled directly onto the loading platform 24 through the front cargo cabin doorway 34.

At step 66, the loading platform 24 may be raised using the lift system 26 to elevate the loading platform 24 supporting the catering carts. An individual may also be supported and elevated by the loading platform 24. In certain embodiments, only the loading platform may elevate from its lower transport position and be elevated to the height of the doorsill of the aircraft. In other embodiments, the cargo cabin 12 may be elevated with the loaded platform 24.

At step 68, the aircraft may be loaded with the cargo. This operation may involve the driver or other individual pushing the wheeled carts from the loading platform 24 to a galley location on the aircraft where the contents of the cargo carts may be accessed by the flight attendants and served to the passengers of the aircraft in flight. Once the cargo is loaded onto the aircraft, the platform 24 may be lowered to its transport position. Before lowering the platform 24, trash, empty catering carts, cart drawers, and other items which may be removed from the passenger cabin of the aircraft may be loaded onto the platform 24. The platform 24 may also support catering carts and allow a drawer exchange or a product refresh to be performed by the individual. A product may be refreshed without actually moving an entire cart from the platform 24 to the aircraft. A drawer exchange may include removing empty or used cart drawers from the cargo cabin and replacing those drawers with fully stocked drawers transported by the cargo cabin 12. The empty or used drawers may be removed from the aircraft and transported to the catering facility on the aircraft loading vehicle 10. Once lowered to transport level, the discarded cargo may be moved from the platform 24 to the cargo cabin 12. The platform may be loaded with additional cargo and the additional cargo may be transferred onto the aircraft after raising the loading platform 24, or the loading may be complete and the aircraft loading vehicle 10 may be prepared to be moved away from the aircraft to allow the aircraft to depart.

Backing the aircraft loading vehicle 10 off and clear of the aircraft may be accomplished by driving the aircraft loading vehicle 10 away from the aircraft from the alternate driving position 20 at step 72. The driver may enter the cargo cabin 12 through the rear doorway 30, which may require opening a rollup door. The driver may then position himself in the alternate driving position 20 and look for any obstacles out of the cargo cabin windows 32. The driver may then start the engine using the alternate ignition switch 44. Then, the driver may engage the gears so that the aircraft loading vehicle 10 moves in reverse away from the aircraft. The driver may use the alternate steering wheel 40 to direct the aircraft loading vehicle 10 carefully away from the aircraft. In the alternate driving position 20, the driver may steer the vehicle using the alternate steering wheel and brake the vehicle using the alternate service brake 48, all while viewing out of the rear and side cargo cabin windows 32 and the rear doorway 30 in the direction of travel. In this manner, the driver may have a clear view of the tarmac behind the aircraft loading vehicle without the cargo cabin 12 or other part of the vehicle 10 blocking the view, and a spotter to direct the driver may not be necessary. The driver may see more of the tarmac and avoid the obstacles, other vehicles, equipment, individuals, and the like. Thus, one person may drive the vehicle to the load position, load and/or unload the aircraft, and back the vehicle 10 away from the aircraft. In certain embodiments, the driver may drive the aircraft loading vehicle 10 from the alternate driving position 20 back to the commissary or catering facility.

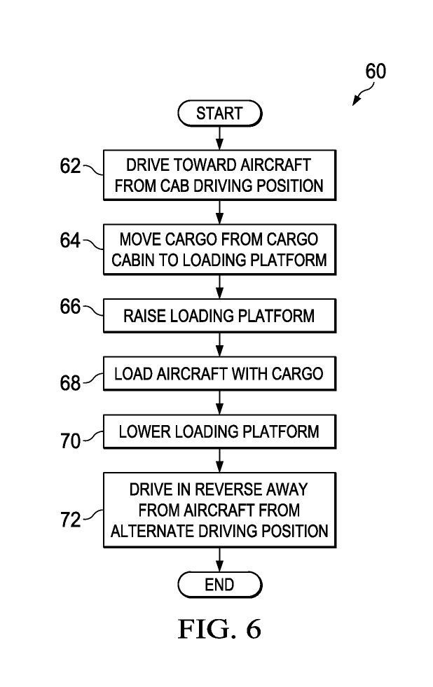

Some of the steps illustrated in FIG. 6 may be combined, modified, or deleted where appropriate, and additional steps may also be added to the flow diagrams. Additionally, steps may be performed in any suitable order without departing from the scope of the invention.

The foregoing description is of exemplary and preferred embodiments. The invention, as defined by the appended claims, is not limited to the described embodiments. Alterations and modifications to the disclosed embodiments may be made without departing from the invention. The meaning of the terms used in the claims are, unless expressly stated otherwise, intended to have ordinary and customary meaning and are not intended to be limited to the details of the illustrated structures or the disclosed embodiments.

What is claimed is:

1. A method of loading an aircraft comprising:
driving a loading vehicle by a driver in a first driving position in a forward direction of travel toward an aircraft, the driver facing the forward direction of travel;
positioning a loading platform of the loading vehicle proximate the aircraft, the loading platform configured to support cargo to be loaded onto the aircraft;
loading the cargo onto the aircraft; and
driving the loading vehicle by the driver in a second driving position in a reverse direction of travel away from the aircraft, the driver facing the reverse direction of travel.

2. The method of claim 1, wherein:
the loading vehicle comprises front wheels and rear wheels;
driving the loading vehicle in the forward direction comprises steering the front wheels; and
driving the loading vehicle in the reverse direction comprises steering the front wheels.

3. The method of claim 2 wherein the loading vehicle comprises a cargo cabin fixed to a chassis, and further comprising:
moving the cargo from the cargo cabin to the loading platform; and
raising the loading platform to a height of a doorsill of the aircraft after moving the cargo to the loading platform.

4. The method of claim 2 wherein driving the loading vehicle in the reverse direction comprises driving the loading vehicle on an airport tarmac at no greater than idle speed.

5. The method of claim 2 wherein steering the front wheels is hydraulically assisted.

6. The method of claim 1 wherein the second driving position is a standing driving position.

7. The method of claim 1 wherein the loading vehicle is an aircraft catering vehicle.

8. The method of claim 1 wherein the loading platform supports at least four wheeled catering carts.

9. The method of claim 1 wherein the steps of driving in the forward direction, positioning the loading platform, loading the cargo, and driving in the reverse direction may be performed by only one individual.

10. An aircraft loading vehicle, comprising:
a chassis;
a first driving position located at a front of an aircraft loading vehicle;
a loading platform coupled to the chassis and being vertically moveable to a doorsill height of an aircraft; and
a cargo cabin coupled to the chassis enclosing a second driving position, the second driving position allowing a driver to face rearward and including a steering controller, a gear selector, and a brake.

11. The aircraft loading vehicle of claim 10 wherein the alternate driving position is located at an interior corner of the cargo cabin.

12. The aircraft loading vehicle of claim 10 wherein the steering controller in the second driving position is operable to steer at least a front wheel of the chassis.

13. The aircraft loading vehicle of claim 10 wherein the cargo cabin is fixed to the chassis.

14. The aircraft loading vehicle of claim 10 further comprising a cab coupled to the chassis and enclosing the first driving position.

15. The aircraft loading vehicle of claim 14 wherein the cab is a half cab.

16. The aircraft loading vehicle of claim 10 wherein the cargo cabin comprises at least one window proximate the second driving position.

17. The aircraft loading vehicle of claim 10 further comprising a hydraulic steering system associated with the chassis, the hydraulic steering system operable to assist steering of at least a front wheel when the steering controller in the second driving position is operated.

18. The aircraft loading vehicle of claim 10 wherein the loading platform is configured to support at least four catering carts and the aircraft loading vehicle further comprising a scissor lift operable to vertically move the loading platform.

19. The aircraft loading vehicle of claim 10 wherein the chassis comprises a modified belt loader chassis.

20. An aircraft loading/unloading vehicle, comprising:
a chassis having a hydraulic steering system;
a half cab coupled to the chassis enclosing a first driving position located at a front of an aircraft loading vehicle;
a platform coupled to the chassis proximate the half cab, the platform being vertically movable to a doorsill height of an aircraft;
a scissor lift operable to vertically move the platform;
a cargo cabin fixed to the chassis and enclosing an alternate driving position, the cargo cabin having at least one window proximate the alternate driving position; and
the second driving position being located at an interior corner of the cargo cabin and allowing a driver to stand and face rearward and including a steering wheel, a gear selector, an ignition switch, and a brake; and
the hydraulic steering system being operable to assist steering of the at least a front wheel when the steering wheel in the second driving position is operated.
